(19) United States
(12) Patent Application Publication
(10) Pub. No.: US 2012/0033049 A1
(43) Pub. Date: Feb. 9, 2012

(54) Apparatus and method of aligning three dimensional camera systems

(76) Inventor: Ferrand David E. Corley, Mississauga (CA)

(21) Appl. No.: 13/137,157

(22) Filed: Jul. 25, 2011

Related U.S. Application Data
(60) Provisional application No. 61/344,494, filed on Aug. 6, 2010.

(51) Int. Cl. H04N 13/02

(52) U.S. Cl. 348/47; 348/E13.074

(57) ABSTRACT

Camera alignment apparatus having a test target with precision framing information along with patterns useful in aligning grayscale, colorimetry, resolution, interocular distance and angle of convergence in a 3-D camera rig.

This application claims priority of U.S. Provisional App. No. 61/344,494 filed Aug. 6 2010, Title; Apparatus and Method of Aligning Three Dimensional Camera Systems, Inventor F D E Corley.

### FIELD OF THE INVENTION

The invention relates to three dimensional camera systems, and in particular to the alignment of such camera systems to optimize the image quality and three dimensional effect of images viewed from such multiple camera systems.

### BACKGROUND OF THE INVENTION

While three dimensional (3-D) or stereoscopic images can be synthesized from a 2-D image, the preferred method is to use multiple cameras, typically two cameras, securely mounted on a 3-D rig and set up to record an image as it would be seen with human stereoscopic vision.

When such camera rigs are made with precision and accurately aligned, the resulting images when viewed in a motion picture theater or on television can be very realistic. All too frequently however, the camera rigs are of poor quality and/or misaligned. Images from such equipment will at best result in viewers receiving eyestrain or headaches and at worst becoming violently ill with nausea, vertigo etc.

It is difficult to align even a single camera to provide accurate or pleasing reproduction of a scene. It is considerably more difficult to align 3-D cameras. Not only must the color and gray scales match, but resolution, lens concentricity, optical axes, interocular distance and convergence must all be precisely aligned. For example, when viewing a 2-D production, any misalignment of the optical axis of the lens has minimal effect. In 3-D however, having the optical axes of the right and left camera lenses moving in different directions can result in painful eyestrain to the viewer.

### BRIEF SUMMARY OF THE INVENTION

This invention provides an apparatus for use in aligning the optical paths of 3-D camera rigs, wherein a primary test target, comprising patterns having useful optical elements such as precision framing, resolution, brightness and colour characteristics, as are known in the trade, also has an open or transparent area located within said primary test target, designed to overcome these limitations.

Further the invention provides such an apparatus wherein a centering scale is provided either within said transparent area or adjacent to it on the front of said primary test target.

Further the invention provides such an apparatus wherein the transparent area enables the comparative positions of one or more secondary test targets attached to the primary target and positioned behind and/or in front of the primary target, to be used in the precise adjustment of two or more cameras

Further the invention provides such an apparatus wherein the secondary target is a small light source similarly adjustable, but located behind said primary test target

Further the invention provides such an apparatus wherein there are two secondary targets, one in front of the primary target, the other behind said primary target.

Further the invention provides such an apparatus wherein the secondary target/s are solid objects.

Further the invention provides such an apparatus wherein the secondary target is an image printed or etched on a clear substrate.

Further the invention provides such an apparatus wherein there are LEDs in the four corners of the test target to facilitate aligning the two cameras

The various features of novelty which characterize the invention are pointed out with more particularity in the claims annexed to and forming a part of this disclosure. For a better understanding of the invention, its operating advantages and specific objects attained by its use, reference should be made to the accompanying drawings and descriptive matter in which there are illustrated and described preferred embodiments of the invention.

### BRIEF DESCRIPTION OF THE DRAWINGS

FIG. 1—Is a Front view of one embodiment of the apparatus;

FIG. 2—is a Side view of the apparatus;

FIG. 3—is an Overhead view of the apparatus as used with a single Camera when aligning the secondary test target;

FIG. 4—is an Overhead view of the apparatus as used with a 3-D Camera system; and,

FIG. 5—is an Adjusting mechanism attached to the primary test target .

### DESCRIPTION OF A PREFERRED EMBODIMENT

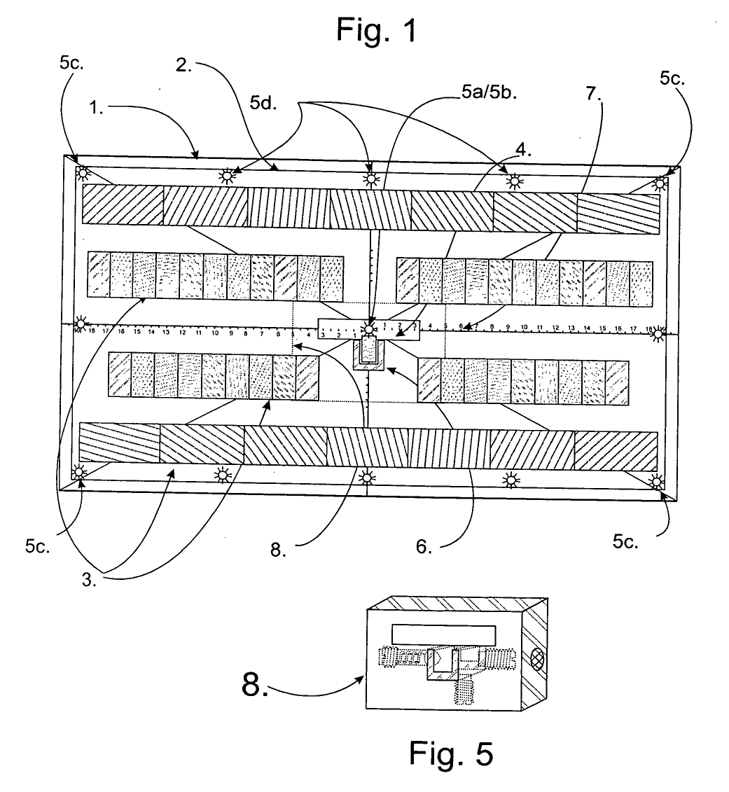

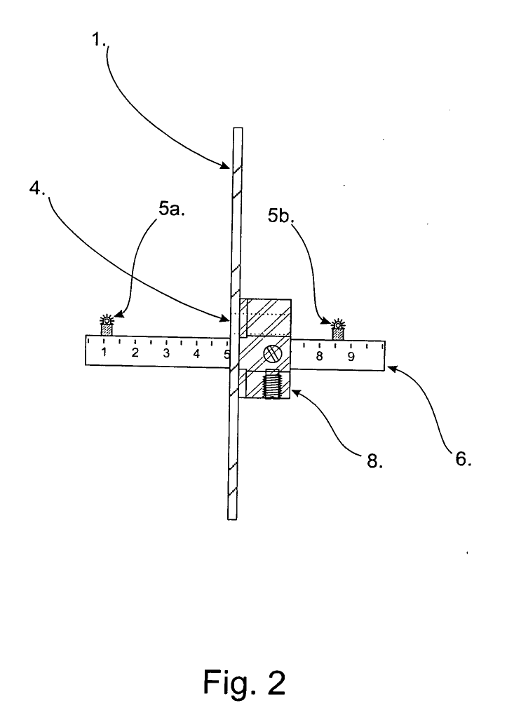

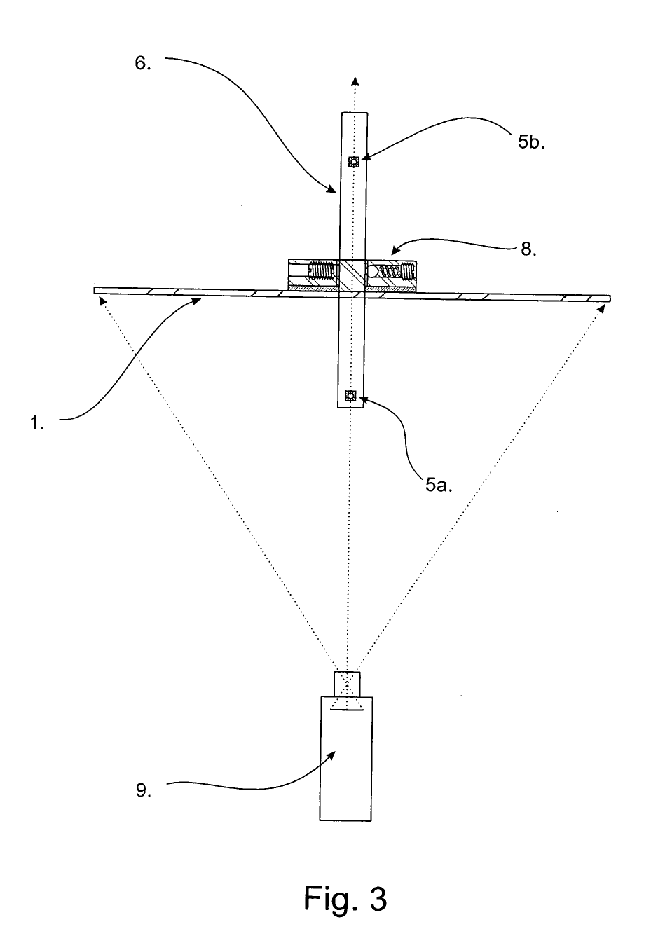

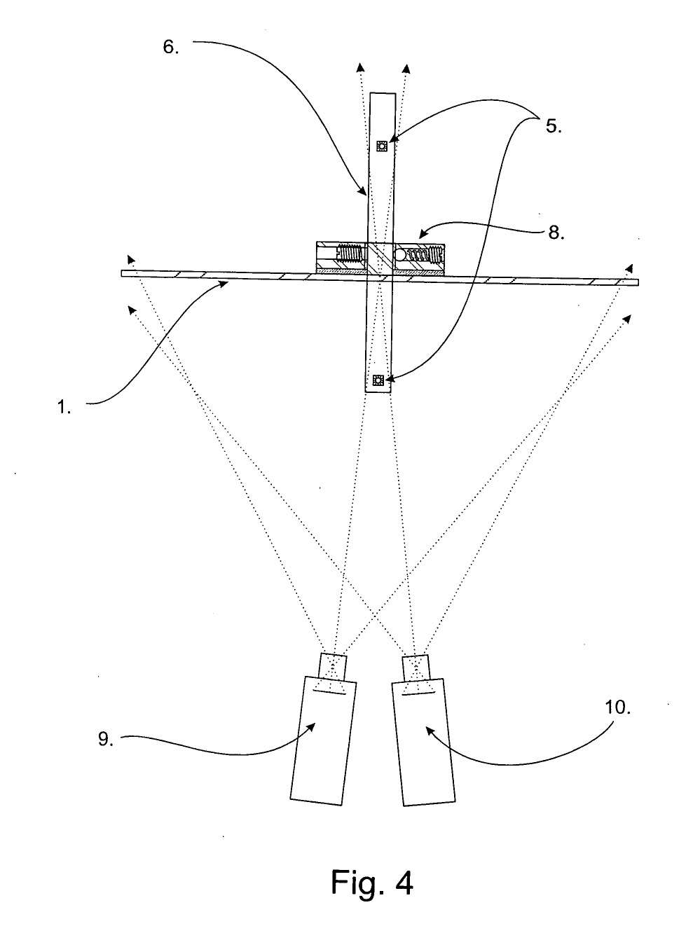

Referring to FIGS. 1-5, a primary test target 1, the front of which comprises framing data 2 enables cameras 9 and 10 to be adjusted for accurate size, centering, level and distortion.

Precision gray tones, color and resolution test elements 3 are used to align and optimize these parameters in the cameras,

An aperture 4 within the primary test target 1, enables a linearly adjustable secondary test target 5a or 5b, located on member 6 to be viewed and adjusted so that it is centered relative to scale 7 located within or adjacent to aperture 4 on said primary test target 1.

The aperture 4 may be a transparent material as part of the test target.

Centering of the secondary test targets 5a/5b relative to scale 7 on primary test target 1 is accomplished using adjusting mechanism 8, attached to and centered on the primary test target 1.

In this mechanism member 6, pivoting relative to the front of the primary test target 1, may be adjusted both right, left, up and down, using adjustment screws, or other well-established adjusting mechanism.

### Method of Use

First ensure that the secondary test target 5a/5b is accurately aligned in the vertical and horizontal planes at 90° to the primary test target 1 and centered relative to scale 7 within or adjacent to aperture 4. This can be accomplished by using set squares both horizontally and vertically, or using a single camera framed accurately on pattern 2, by adjusting mechanism 8, so that said secondary test target 5a/5b , positioned on -member 6, at a distance from primary test target 1, is centered relative to scale 7 within or adjacent to aperture 4.

By varying the distance of the 3-D cameras to primary test target 1 and positioning secondary test targets 5a/5b on member 6 a measured distance from primary test target 1, interocular and convergence settings on the 3-D cameras can be performed with accuracy and repeatability, enabling a director of photography to produce the particular stereoscopic “look” that he or she has in mind.

To further assist in aligning multiple cameras, small lamps or LEDs, 5c are positioned in the corners of the chart. To assist in synchronizing images from cameras when editing, additional LEDs 5d are provided. The additional LEDs 5d are turned on and off sequentially. The switching speed can be synchronized with the frame rate of the cameras, or they can run “wild”. Typically the number of LEDs found useful for synchronizing multiple cameras is between six and eighteen. Corner LEDs 5c can be included in the switching pattern with LEDs 5d. The sequencing can be linear or in a shape such as a square or circle, or as in FIG. 1 showing a rectangle.

The foregoing is a description of a preferred embodiment of the invention which is given here by way of example only. The invention is not to be taken as limited to any of the specific features as described, but comprehends all such variations thereof as come within the scope of the appended claims.

What is claimed is;

1. An apparatus for use in aligning the optical paths of 3-D camera rigs, and comprising;
a primary test target;
optical element patterns defined by said test target; and,
an open area located within said primary test target.

2. An apparatus as claimed in claim 1 wherein said optical elements are selected from the group comprising precision framing, resolution, brightness and color characteristics.

3. An apparatus as claimed in claim 1 wherein said open area comprises a transparent portion of said test target.

4. An apparatus as claimed in claim 3 including a centering scale on said primary test target.

5. An apparatus as claimed in claim 4 wherein said centering scale is within a transparent area.

6. An apparatus as claimed in claim 3 wherein at least one secondary target is located behind said primary test target and in registration with said transparent portion.

7. An apparatus as claimed in claim 1 including at least one illuminated light source.

8. An apparatus as claimed in claim 1 including at least one solid secondary target at a distance from said primary test target, comprising indicia drawn on a transparent portion.

9. An apparatus as claimed in claim 1 wherein said secondary target is a light source located behind said primary test target.

10. An apparatus as claimed in claim 9 including two secondary targets comprising a light of a first color in front of said primary test target, a light of a second color behind said primary test target

11. An apparatus as claimed in claim 6, wherein said secondary target includes solid objects

12. An apparatus as claimed in claim 6, wherein said secondary target is an image on a clear substrate.

13. An apparatus as claimed in claim 6 wherein the secondary target is a light source in front of or behind the primary test target, said secondary light source being adjustably positionable relative to said primary target.

14. An apparatus as claimed in claim 6 wherein there are two secondary targets, one in front of the primary target, the other behind said primary target

15. An apparatus as claimed in claim 1 including LED lights at the corners of said primary test target.

16. An apparatus as claimed in claim 15 including additional LED lights which are adapted to be switched on and off in sequence to enable synchronization of images from multiple cameras.
